(19) United States
(12) Patent Application Publication
(10) Pub. No.: US 2025/0063636 A1
(43) Pub. Date: Feb. 20, 2025

(54) MULTIZONE CERAMIC HEATER

(71) Applicant: NGK INSULATORS, LTD., Nagoya-City (JP)

(72) Inventor: Yutaka UNNO, Handa-Shi (JP)

(73) Assignee: NGK INSULATORS, LTD., Nagoya-City (JP)

(21) Appl. No.: 18/675,244

(22) Filed: May 28, 2024

Related U.S. Application Data
(63) Continuation of application No. PCT/JP2023/029889, filed on Aug. 18, 2023.

(51) Int. Cl. H05B 3/28

(52) U.S. Cl. CPC H05B 3/283; H05B 2203/005; H05B 2203/016

(57) ABSTRACT

There is provided a multizone ceramic heater including a ceramic plate including an inner zone and an outer zone, an inner zone heater circuit embedded in the inner zone, an outer zone heater circuit embedded in the outer zone, one pair of first feeding terminals for feeding power to the inner zone heater circuit, one pair of second feeding terminals for feeding power to the outer zone heater circuit, and one pair of jumpers embedded in the inner zone of the ceramic plate, one of which connects one of the second feeding terminals and the outer zone heater circuit by a first junction and the other of which connects the other of the second feeding terminals and the outer zone heater circuit by a second junction. Thicknesses of the jumpers are from 1.2 to 3.0 times a thickness of the outer zone heater circuit.

### CROSS-REFERENCE TO RELATED APPLICATION

This application is a continuation application of PCT/JP2023/029889 filed Aug. 18, 2023, the entire contents of which are incorporated herein by reference.

### BACKGROUND OF THE INVENTION

### 1. Field of the Invention

The present disclosure relates to a multizone ceramic heater.

### 2. Description of the Related Art

In a deposition apparatus for a semiconductor manufacturing process, a ceramic heater is used as a support stage for controlling a temperature of a wafer such that the temperature is uniform. One including a ceramic plate on which a wafer is to be placed and a cylindrical ceramic shaft which is attached to the ceramic plate is widely used as such a ceramic heater. A multizone ceramic heater having a plurality of heating zones is also known as a ceramic heater.

Patent Literature 1 (JP2020-191315A) discloses a heating apparatus including, in a plate-shaped member, a first heater electrode which is arranged in a generally circular first region and a second heater electrode which is arranged in a generally annular second region around the first region. The heating apparatus includes a common driver electrode which is electrically connected to all of the plurality of heater electrodes and is electrically connected to a common feeding terminal, and the common driver electrode has a thick portion having a larger thickness than thicknesses of other portions in the common driver electrode. That is, a thickness of the common driver electrode is disclosed to be locally different in a plane of the common driver electrode. Patent Literature 2 (JP2015-191837A) discloses a layered heating element having an inner heater and an outer heater around the outside of the inner heater. The layered heating element includes a body portion made of ceramic, heaters which are built into the body portion, a terminal attached to one end in a thickness direction of the body portion, and a feeding path which feeds power from the terminal to the heaters. The feeding path is composed of a combination of a plurality of conductive layers which are provided in the body portion and a plurality of through-vias. Of the plurality of conductive layers, a conductive layer X which is located closer to the terminal than to the heaters has a junction P with a through-via α and a junction Q with a through-via B and includes at least a part of a path connecting the junction P and the junction Q. The conductive layer X has a region AX which is larger in film thickness than a region surrounding the region AX.

### CITATION LIST

### Patent Literature

Patent Literature 1: JP2020-191315A
Patent Literature 2: JP2015-191837A

### SUMMARY OF THE INVENTION

Ceramic heaters are required to have a small temperature difference in a plane where a wafer is placed (i.e., thermal uniformity). Along with recent process miniaturization and higher integration, ceramic heaters are required to have a much higher degree of thermal uniformity. In this view, it is desirable to minimize a temperature difference between a place with a resistance heating element and a place without a resistance heating element. To this end, resistance heating elements are preferably arranged throughout the entire region of a ceramic heater, and promising candidates for the arrangement include a printing-based resistance heating element. However, in a multizone ceramic heater in which a ceramic shaft is arranged at a central portion of a ceramic plate with thin resistance heating elements embedded therein, an electrical connection path (jumper wiring) from the plate central portion to a resistance heating element at a plate outer periphery is likely to have a local hot spot or cool spot due to heat generated in the electrical connection path itself. This may adversely affect thermal uniformity of the entire plate portion of the multizone ceramic heater.

The present inventors have currently found that setting a thickness of a jumper within the range from 1.2 to 3.0 times a thickness of an outer zone heater circuit in a multizone ceramic heater including an inner zone heater circuit, the outer zone heater circuit, and the jumper makes it possible to achieve satisfactory thermal uniformity while suppressing breakage at the time of manufacture or at other times.

Thus, an object of the present invention is to provide a multizone ceramic heater capable of achieving satisfactory thermal uniformity while suppressing breakage at the time of manufacture or at other times.

The present disclosure provides the following aspects.

### [Aspect 1]

A multizone ceramic heater comprising:
a disk-shaped ceramic plate having a first surface on which a wafer is to be placed and a second surface opposite to the first surface, the ceramic plate including an inner zone defined as a circular region within a predetermined distance from a center of the ceramic plate and an outer zone defined as an annular region outside the inner zone when the ceramic plate is viewed in plan view;
an inner zone heater circuit embedded parallel to the first surface in the inner zone of the ceramic plate;
an outer zone heater circuit embedded parallel to the first surface at a depth position different from the inner zone heater circuit in the outer zone of the ceramic plate;
one pair of first feeding terminals for feeding power to the inner zone heater circuit which are provided at a central portion of the inner zone of the ceramic plate;
one pair of second feeding terminals for feeding power to the outer zone heater circuit which are provided at the central portion of the inner zone of the ceramic plate; and
one pair of jumpers separated from each other which are embedded parallel to the first surface at a same depth position as the outer zone heater circuit in the inner zone of the ceramic plate, one of the one pair of jumpers electrically connecting one of the second feeding terminals and the outer zone heater circuit by a first junction, the other of the one pair of jumpers electrically connecting the other of the second feeding terminals and the outer zone heater circuit by a second junction at a position different from the first junction,
wherein each of the inner zone heater circuit, the outer zone heater circuit, and the jumpers is a low-profile element composed of a resistance heating element selected from the group consisting of a printed pattern, foil, perforated metal, and a mesh, and
wherein thicknesses of the jumpers are from 1.2 to 3.0 times a thickness of the outer zone heater circuit.

### [Aspect 2]

The multizone ceramic heater according to aspect 1, wherein the outer zone is composed of a plurality of outer subzones demarcated by dividing the outer zone into arc shapes, and linear boundary regions which are not crossed by the outer zone heater circuit are present in a radial direction of the ceramic plate between the outer subzones adjacent in a circumferential direction so as not to completely split the outer zone, and
wherein the outer zone heater circuit is provided to start from the first junction in one direction or two directions, and meander, for each of the start directions, through a single continuous course while alternating travel in the circumferential direction and turnback in front of the boundary region so as to pass through a generally entire region of each of the plurality of outer subzones, and arrive at the second junction.

### [Aspect 3]

The multizone ceramic heater according to aspect 2, wherein when the ceramic plate is viewed in plan view, the boundary region and each of the first junction and the second junction are arranged to be spaced such that an angle which a straight line through a center in the circumferential direction of the boundary region closest to the junction and a center of the ceramic plate forms with a straight line through the center in the circumferential direction of the junction and the center of the ceramic plate is equal to or more than 20°.

### [Aspect 4]

The multizone ceramic heater according to any one of aspects 1 to 3, wherein when each of the first junction and the second junction is regarded as an arc constituting a part of a circle around an outer perimeter of the inner zone, a central angle of each of the arcs is within the range from 6.0 to 10.0°.

### [Aspect 5]

The multizone ceramic heater according to any one of aspects 1 to 4, wherein the outer zone heater circuit is provided to start from the first junction in one direction and arrive at the second junction through a single continuous course so as to form a series circuit.

### [Aspect 6]

The multizone ceramic heater according to any one of aspects 1 to 4, wherein the outer zone heater circuit is provided to start from the first junction in two directions and arrive, for each of the start directions, at the second junction through a single continuous course so as to form a parallel circuit.

### [Aspect 7]

The multizone ceramic heater according to any one of aspects 1 to 6, wherein when the ceramic plate is viewed in plan view, each of the one pair of jumpers and the one pair of second feeding terminals is arranged symmetric with respect to a perpendicular bisector of a line segment connecting the one pair of second feeding terminals.

### [Aspect 8]

The multizone ceramic heater according to any one of aspects 1 to 7, wherein each of the inner zone heater circuit, the outer zone heater circuit, and the jumpers has the form of a printed pattern.

### [Aspect 9]

The multizone ceramic heater according to any one of aspects 1 to 8, wherein the thickness of the outer zone heater circuit is uniform in an in-plane direction, and the thicknesses of the jumpers are uniform in the in-plane direction.

### [Aspect 10]

The multizone ceramic heater according to any one of aspects 1 to 9, further comprising an RF electrode and/or an ESC electrode embedded at a depth position, closer to the first surface than the inner zone heater circuit and the jumpers are, in the ceramic plate.

### [Aspect 11]

The multizone ceramic heater according to any one of aspects 1 to 10, wherein the ceramic plate contains aluminum nitride or aluminum oxide.

### [Aspect 12]

The multizone ceramic heater according to any one of aspects 1 to 11, further comprising a cylindrical ceramic shaft which is concentrically attached to the second surface of the ceramic plate and includes an internal space.

### [Aspect 13]

The multizone ceramic heater according to any one of aspects 1 to 12, wherein the resistance heating element contains at least one selected from the group consisting of tungsten, molybdenum, a tungsten-molybdenum alloy, tungsten carbide, a tungsten carbide-titanium nitride composite material, and a tungsten carbide-aluminum oxide composite material.

### [Aspect 14]

The multizone ceramic heater according to any one of aspects 1 to 13, wherein the thicknesses of the jumpers are from 1.8 to 3.0 times the thickness of the outer zone heater circuit.

### BRIEF DESCRIPTION OF THE DRAWINGS

FIG. 1 is a schematic top view showing one example of a multizone ceramic heater according to the present invention.

FIG. 2 is a schematic sectional view of the multizone ceramic heater shown in FIG. 1.

FIG. 3 is a schematic top view of the simplified multizone ceramic heater for conceptually explaining a series circuit.

FIG. 4 is a schematic top view of the simplified multizone ceramic heater for conceptually explaining a parallel circuit.

FIG. 5 is a schematic top view showing another one example of the multizone ceramic heater and corresponds to Example 1.

FIG. 6 is a schematic top view showing another one example of the multizone ceramic heater and corresponds to Examples 2 and 10.

FIG. 7 is a schematic top view showing another one example of the multizone ceramic heater and corresponds to Examples 3 and 5.

FIG. 8 is a schematic top view showing another one example of the multizone ceramic heater and corresponds to Examples 4, 7, and 8.

FIG. 9 is a schematic top view showing another one example of the multizone ceramic heater and corresponds to Example 6.

FIG. 10 is a schematic top view showing one example of the multizone ceramic heater and corresponds to Example 9 (a comparative example).

FIG. 11 is a schematic sectional view showing the multizone ceramic heater shown in FIG. 10 and corresponds to Example 9 (the comparative example).

### DETAILED DESCRIPTION OF THE INVENTION

A multizone ceramic heater according to the present invention is a table made of ceramic for supporting a wafer in a semiconductor manufacturing apparatus. Typically, the ceramic heater according to the present invention can be a ceramic heater for a semiconductor deposition apparatus. Typical examples of a deposition apparatus include CVD (chemical vapor deposition) apparatuses (e.g., a thermal CVD apparatus, a plasma CVD apparatus, a photo CVD apparatus, and a MOCVD apparatus) and PVD (physical vapor deposition) apparatuses.

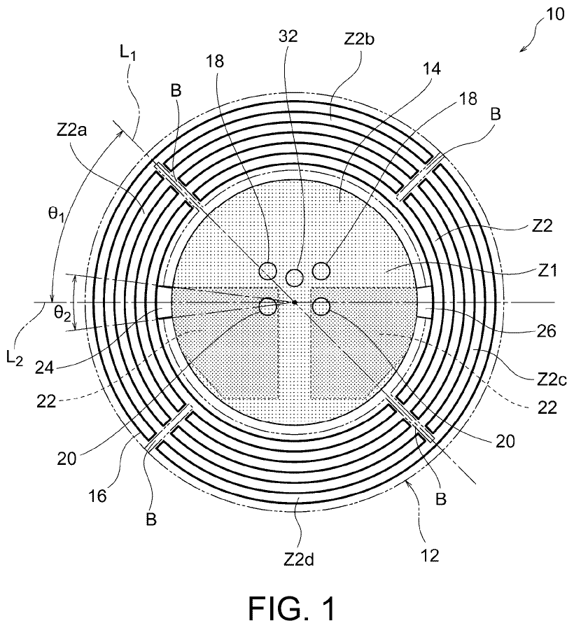

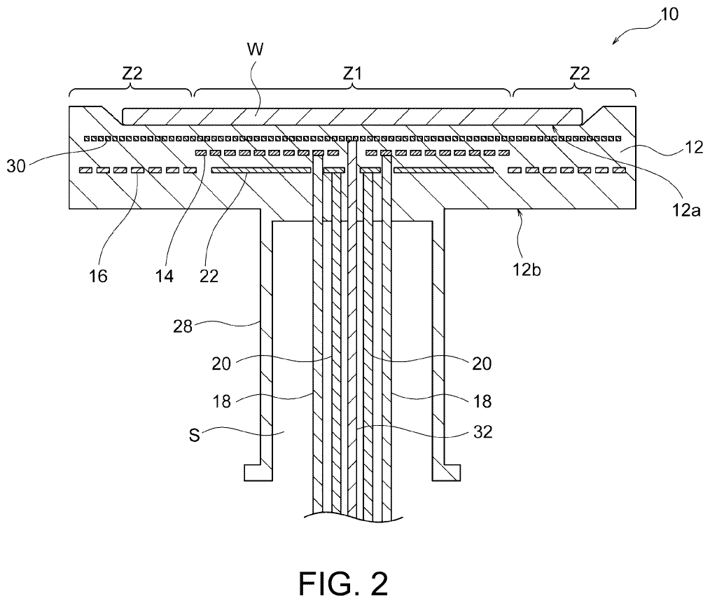

One aspect of the multizone ceramic heater is shown in FIGS. 1 and 2. A multizone ceramic heater 10 shown in FIGS. 1 and 2 includes a ceramic plate 12, an inner zone heater circuit 14, an outer zone heater circuit 16, one pair of first feeding terminals 18, one pair of second feeding terminals 20, and one pair of jumpers 22. The ceramic plate 12 is disk-shaped and has a first surface 12a on which a wafer W is to be placed and a second surface 12b opposite to the first surface 12a. The ceramic plate 12 includes an inner zone Z1 which is defined as a circular region within a predetermined distance from a center of the ceramic plate 12 and an outer zone Z2 defined as an annular region outside the inner zone Z1 when viewed in plan view. While the inner zone heater circuit 14 is embedded parallel to the first surface 12a in the inner zone Z1 of the ceramic plate 12, the outer zone heater circuit 16 is embedded parallel to the first surface 12a at a depth position different from the inner zone heater circuit 14 in the outer zone Z2 of the ceramic plate 12. The one pair of first feeding terminals 18 is a terminal for feeding power to the inner zone heater circuit 14 and is provided at a central portion of the inner zone Z1 of the ceramic plate 12. The one pair of second feeding terminals 20 is a terminal for feeding power to the outer zone heater circuit 16 and is provided at the central portion of the inner zone Z1 of the ceramic plate 12. The one pair of jumpers 22 is separated from each other and is embedded parallel to the first surface 12a at the same depth position as the outer zone heater circuit 16 in the inner zone Z1 of the ceramic plate 12. While one of the one pair of jumpers 22 electrically connects one of the second feeding terminals 20 and the outer zone heater circuit 16 by a first junction 24, the other of the one pair of jumpers 22 electrically connects the other of the second feeding terminals 20 and the outer zone heater circuit 16 by a second junction 26 at a different position from the first junction 24. Each of the inner zone heater circuit 14, the outer zone heater circuit 16, and the jumpers 22 is a low-profile element which is composed of a resistance heating element selected from the group consisting of a printed pattern, foil, perforated metal, and a mesh. A thickness of the jumper 22 is from 1.2 to 3.0 times a thickness of the outer zone heater circuit 16. Setting the thickness of the jumper 22 within the range from 1.2 to 3.0 times the thickness of the outer zone heater circuit 16 in the multizone ceramic heater 10 including the inner zone heater circuit 14, the outer zone heater circuit 16, and the jumpers 22, as described above, makes it possible to achieve satisfactory thermal uniformity while suppressing breakage at the time of manufacture or at other times.

As described earlier, along with recent process miniaturization and higher integration, ceramic heaters are required to have a much higher degree of thermal uniformity (e.g., an in-plane maximum temperature difference of 1° C. or less). To this end, resistance heating elements are preferably arranged throughout the entire region of a ceramic heater, and promising candidates for the arrangement include a printing-based resistance heating element. However, in a multizone ceramic heater in which a ceramic shaft is arranged at a central portion of a ceramic plate with thin resistance heating elements (with thicknesses of, for example, 100 μm or less) embedded therein, an electrical connection path (jumper wiring) from the plate central portion to a resistance heating element at a plate outer periphery is likely to have a local hot spot or cool spot due to heat generated in the electrical connection path itself. This may adversely affect thermal uniformity of the entire plate portion of the multizone ceramic heater. In this respect, according to the present invention, thermal uniformity as described above can be improved by setting the thickness of the jumper 22 1.2 or more times the thickness of the outer zone heater circuit 16. This is because the jumper 22 is made thicker than the outer zone heater circuit 16, which reduces a resistance of the jumper 22 that is composed of a resistance heating element like the inner zone heater circuit 14 and the outer zone heater circuit 16. As a result, the amount of heat generation in the jumper 22 can be reduced, which leads to a reduction in local hot spots. However, it is not desirable that the jumper 22 be by far thicker than the outer zone heater circuit 16. For example, if the thickness of the jumper 22 is more than three times (e.g., four or more times) the thickness of the outer zone heater circuit 16, a large level difference may be produced at a portion where a thickness of a resistance heating element changes in a junction between the jumper 22 and the outer zone heater circuit 16 (i.e., the first junction 24 or the second junction 26), and a stress may concentrate on the level-difference portion to cause breakage. Concentration of a stress on a level-difference portion and breakage arising from the concentration are likely to occur during manufacture of a ceramic heater (particularly at the time of firing a ceramic plate or at the time of bonding a ceramic shaft to the ceramic plate), and breakage at the time of use of the ceramic heater (i.e. during operation of a semiconductor manufacturing apparatus) is also conceivable. For example, in the former case, a stress generated in a ceramic plate formation process is increased in a ceramic plate firing process, and the stress is likely to concentrate on the level-difference portion. In the latter case, since the ceramic plate is exposed to a high temperature during operation of the semiconductor manufacturing apparatus, a stress is likely to concentrate on the level-difference portion due to thermal expansion of the ceramic plate. In this respect, breakage arising from such stress concentration can be effectively suppressed by making the thickness of the jumper 22 3.0 or less times the thickness of the outer zone heater circuit 16. For the above-described reason, the thickness of the jumper 22 is from 1.2 to 3.0 times the thickness of the outer zone heater circuit 16, preferably from 1.3 to 2.8 times, more preferably from 1.4 to 2.5 times, and further preferably from 1.5 to 2.0 times.

When the ceramic plate 12 is viewed in plan view, an area of the jumpers 22 preferably constitutes from 30 to 80% of an area of the inner zone Z1, more preferably from 35 to 80%, and further preferably from 40 to 80%. Since the large-area jumper 22 has a low resistance, the amount of heat generation arising from the jumpers 22 can be reduced, which contributes to enhancement of thermal uniformity. Generally, if there is a level difference in an electrical connection path plane including the large-area jumper 22, the level difference itself serves as a stress generation source and is likely to cause breakage. In this respect, in the present invention, the thickness of the jumper 22 is made 3.0 or less times the thickness of the outer zone heater circuit 16, as described above. This allows effective suppression of such breakage arising from a stress.

In terms of excellent thermal conductivity, high electrical insulation, thermal expansion characteristics close to silicon, and the like, a main portion (i.e., a ceramic base) other than embedded members, such as the inner zone heater circuit 14, the outer zone heater circuit 16, and the jumpers 22, of the ceramic plate 12 preferably contains aluminum nitride or aluminum oxide, more preferably aluminum nitride.

The ceramic plate 12 is disk-shaped. A shape in plan view of the disk-shaped ceramic plate 12 need not be a complete circular shape and may be, for example, an incomplete circular shape which is chipped like an orientation flat. The size of the ceramic plate 12 may be appropriately determined in accordance with a diameter of a wafer which is assumed to be used and is not particularly limited. If the ceramic plate 12 is circular, the diameter is typically from 150 to 450 mm and is, for example, about 300 mm.

The ceramic plate 12 includes the inner zone Z1 and the outer zone Z2 when viewed in plan view. The inner zone Z1 is defined as a circular region within the predetermined distance from the center of the ceramic plate 12. The outer zone Z2 is defined as an annular region outside the inner zone Z1. The outer zone Z2 is preferably composed of a plurality of outer subzones Z2a, Z2b, Z2c, and Z2d which are demarcated by dividing the outer zone Z2 into arc shapes on the point that the outer zone heater circuit 16 is easily disposed throughout the entire region of the outer zone Z2. The outer zone Z2 may concentrically have two or more annular regions which do not overlap with each other and have different sizes. In this case, the outer zone Z2 at least has a first outer zone close to the inner zone Z1 and a second outer zone located outside the first outer zone. A third or subsequent outer zone may be present outside the second outer zone as needed.

The inner zone heater circuit 14 is embedded parallel to the first surface 12a in the inner zone Z1 of the ceramic plate 12. The one pair of first feeding terminals 18 for feeding power to the inner zone heater circuit 14 is provided at the central portion of the inner zone Z1 of the ceramic plate 12. Preferably, the respective first feeding terminals 18 are connected to two ends of the inner zone heater circuit 14. Two or more pairs of first feeding terminals 18 may be present. The first feeding terminals 18 are rod-shaped, and the inner zone heater circuit 14 is connected to a heater power source (not shown) via the rod-shaped first feeding terminals 18.

The outer zone heater circuit 16 is embedded parallel to the first surface 12a at a depth position different from the inner zone heater circuit 14 in the outer zone Z2 of the ceramic plate 12. Referring to FIG. 2, although the inner zone heater circuit 14 is embedded above the outer zone heater circuit 16 (i.e., at a depth position closer to the first surface 12a), the inner zone heater circuit 14 is not limited to this. Thus, the inner zone heater circuit 14 may be embedded below the outer zone heater circuit 16 (i.e., at a depth position closer to the second surface 12b). The one pair of second feeding terminals 20 for feeding power to the outer zone heater circuit 16 is provided at the central portion (but a position different from the first feeding terminal 18) of the inner zone Z1 of the ceramic plate 12. Since the one pair of second feeding terminals 20 is arranged at positions separate from the outer zone heater circuit 16, the one pair of second feeding terminals 20 is electrically connected to the outer zone heater circuit 16 via the one pair of jumpers 22. Two or more pairs of second feeding terminals 20 may be present. The second feeding terminals 20 are rod-shaped, and the outer zone heater circuit 16 is connected to the heater power source (not shown) via the jumpers 22 and the rod-shaped second feeding terminals 20.

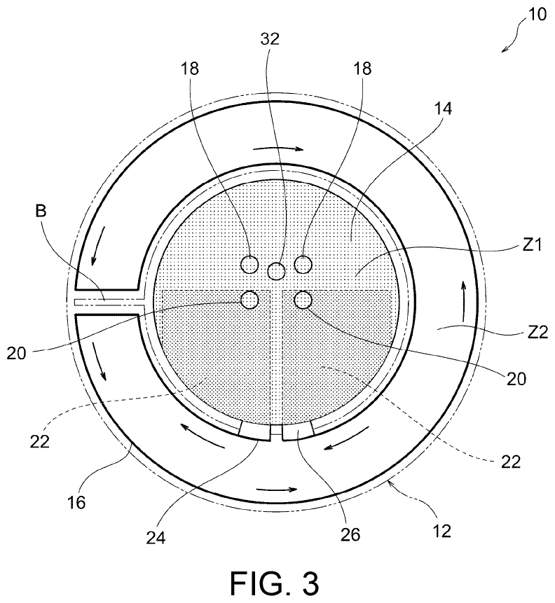

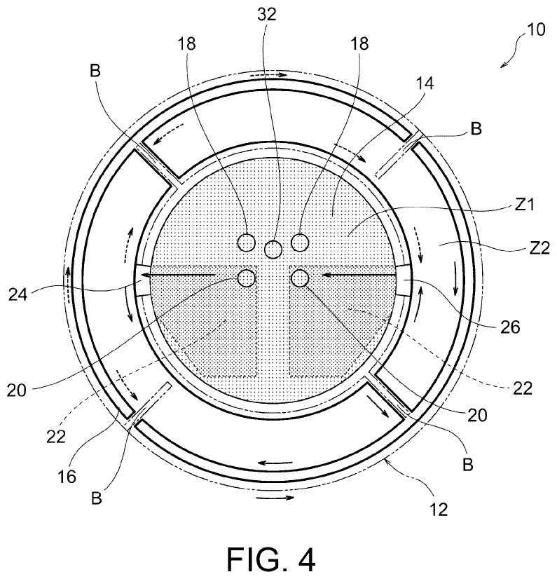

The outer zone heater circuit 16 may be either a series circuit or a parallel circuit. That is, as conceptually shown with arrows representing a current direction in FIG. 3, the outer zone heater circuit 16 may be provided to start from the first junction 24 in one direction and arrive at the second junction 26 through a single continuous course so as to form a series circuit. In this case, the first junction 24 and the second junction 26 are preferably arranged at two respective ends of the outer zone heater circuit 16. Alternatively, as conceptually shown with arrows representing current directions in FIG. 4, the outer zone heater circuit 16 may be provided to start from the first junction 24 in two directions and arrive, for each start direction, at the second junction 26 through a single continuous course so as to form a parallel circuit. In this case, each of the first junction 24 and the second junction 26 is preferably arranged at a position as a start position or an end position of the outer zone heater circuit 16. The outer zone heater circuit 16 shown in FIG. 1 corresponds to the parallel circuit. In terms of thermal uniformity, the series circuit and the parallel circuit are comparable. In terms of preventing a rise in resistance value, the outer zone heater circuit 16 is preferably a parallel circuit. If the outer zone heater circuit 16 is a parallel circuit, the outer zone heater circuit 16 can achieve a resistance value close to a coiled resistance heating element used in an existing ceramic heater.

The one pair of jumpers 22 is embedded parallel to the first surface 12a at the same depth position as the outer zone heater circuit 16 in the inner zone Z1 of the ceramic plate 12. While the one pair of jumpers 22 is separated from each other, one jumper 22 electrically connects one of the second feeding terminals 20 and the outer zone heater circuit 16 by the first junction 24, the other jumper 22 electrically connects the other of the second feeding terminals 20 and the outer zone heater circuit 16 by the second junction 26 at a position different from the first junction 24. Two or more pairs of jumpers 22 may be present. Preferably, the first junction 24 and the second junction 26 are arranged at the two respective ends of the outer zone heater circuit 16.

Each of the one pair of jumpers 22 and the one pair of second feeding terminals 20 is preferably arranged symmetric with respect to a perpendicular bisector of a line segment connecting the one pair of second feeding terminals 20 when the ceramic plate 12 is viewed in plan view. This configuration allows equalization of feeding path lengths from the one pair of second feeding terminals 20 to the outer zone heater circuit 16 via the one pair of jumpers 22 and allows much easier achievement of satisfactory thermal uniformity.

As described earlier, each of the inner zone heater circuit 14, the outer zone heater circuit 16, and the jumpers 22 is a low-profile element composed of a resistance heating element. The low-profile element has a form selected from the group consisting of a printed pattern, foil, perforated metal, and a mesh, particularly preferably the form of a printed pattern. If each of the inner zone heater circuit 14, the outer zone heater circuit 16, and the jumpers 22 is a low-profile element in the form of a printed pattern, it is possible to effectively manufacture the outer zone heater circuit 16, and the jumpers 22 by printing while controlling their thicknesses. A thickness of a low-profile element composed of a resistance heating element is preferably equal to or less than 100 μm, more preferably from 10 to 100 μm, and further preferably from 10 to 60 μm. When low-profile elements are formed by printing or the like, variation in thickness is unlikely to occur if thicknesses of the low-profile elements are equal to or more than 10 μm. A resistance heating element commonly used in a ceramic heater may be used as a resistance heating element constituting a low-profile element, and the resistance heating element is not particularly limited. Examples of a preferred resistance heating element include tungsten, molybdenum, a tungsten-molybdenum alloy, tungsten carbide, a tungsten carbide-titanium nitride composite material, a tungsten carbide-aluminum oxide composite material, and a combination thereof.

Preferably, the thickness of the outer zone heater circuit 16 is uniform in an in-plane direction, and the thickness of the jumper 22 is uniform in the in-plane direction. The expression “the thickness of the outer zone heater circuit 16 or the jumper 22 is uniform in the in-plane direction” herein means that the thickness of the outer zone heater circuit 16 or the jumper 22 is purposefully set not to be partially changed. Thus, the thickness is not required to be completely uniform in the in-plane direction, and the thickness can be regarded as uniform in the in-plane direction as long as the thickness is a generally uniform thickness (e.g., variation in thickness is equal to or less than 5%) to the extent that the thickness is recognized to be not purposefully changed. Variation in thickness here can be calculated as a value obtained by dividing a difference between a maximum thickness value and a minimum value by an average thickness and multiplying the quotient by 100. The above-described uniformization of a thickness of a resistance heating element in each of the outer zone heater circuit 16 and the jumpers 22 in the in-plane direction makes it possible to eliminate unevenness in resistance arising from thickness variation and achieve satisfactory thermal uniformity. This results in more effective achievement of effects (i.e., suppression of breakage and satisfactory thermal uniformity) obtained by making the thickness of the jumper 22 from 1.2 to 3.0 times the thickness of the outer zone heater circuit 16. In this sense, the thickness of the inner zone heater circuit 14 is also preferably uniform in the in-plane direction. Since each of the inner zone heater circuit 14, the outer zone heater circuit 16, and the jumpers 22 is a low-profile element composed of a resistance heating element, such as a printed pattern, the thickness thereof can be said to be suited for uniformization in the in-plane direction.

The outer zone Z2 is preferably composed of the plurality of outer subzones Z2a, Z2b, Z2c, and Z2d demarcated by dividing the outer zone Z2 into arc shapes. In this case, linear boundary regions B which are not crossed by the outer zone heater circuit 16 are preferably present in a radial direction of the ceramic plate 12 between the outer subzones Z2a, Z2b, Z2c, and Z2d adjacent in a circumferential direction so as not to completely split the outer zone Z2. The outer zone heater circuit 16 is preferably provided to start from the first junction 24 in one direction or two directions, and meander, for each start direction, through a single continuous course while alternating travel in the circumferential direction and turnback in front of the boundary region B so as to pass through the generally entire region of each of the outer subzones Z2a, Z2b, Z2c, and Z2d, and arrive at the second junction 26. In this manner, the outer zone heater circuit 16 can be disposed throughout the outer zone Z2. That is, it is possible to dispose the outer zone heater circuit 16 throughout each of the outer subzones Z2a, Z2b, Z2c, and Z2d and dispose the outer zone heater circuit 16 in portions which are not blocked by the boundary regions B between the outer subzones Z2a, Z2b, Z2c, and Z2d, and dispose the outer zone heater circuit 16 as continuous wiring from the first junction 24 to the second junction 26 throughout the entire surface of the ceramic plate 12 in each of the outer subzones Z2a, Z2b, Z2c, and Z2d. In this aspect as well, the outer zone heater circuit 16 can be either a series circuit or a parallel circuit, as described earlier. Preferably, the outer zone heater circuit 16 is a parallel circuit which can make an electrical resistance value of the outer zone heater circuit 16 lower than in a series circuit.

In the above-described aspect having the outer subzones Z2a, Z2b, Z2c, and Z2d, circumferential positions of the first junction 24 and the second junction 26 are preferably set so as not to coincide with circumferential positions of the boundary regions B. This suppresses production of local hot spots and allows achievement of more satisfactory thermal uniformity. Specifically, as shown in FIG. 1, each of the first junction 24 and the second junction 26 is preferably arranged in the manner below when the ceramic plate 12 is viewed in plan view. The junction 24 or 26 and the boundary region B closest to the junction 24 or 26 are preferably arranged to be spaced such that an angle θ₁ (hereinafter referred to as the angle θ₁ of deviation) which a straight line L₁ through a center in the circumferential direction of the boundary region B and the center of the ceramic plate 12 forms with a straight line L₂ through a center in the circumferential direction of the junction 24 or 26 and the center of the ceramic plate is equal to or more than 20°. Note that, if a plurality of candidates are present for the straight line L₁ and/or the straight line L₂, the straight line L₁ and the straight line L₂ may be determined so as to provide the minimum angle θ₁ of deviation. The angle θ₁ of deviation is equal to or more than 20°, preferably equal to or more than 30°, more preferably equal to or more than 40°, further preferably equal to or more than 45°, and particularly preferably from 45 to 90°. The angle θ₁ of deviation can be said to be an angle of deviation of the center in the circumferential direction of the junction 24 or 26 from a centerline of the boundary region B extending in the radial direction.

If each of the first junction 24 and the second junction 26 is regarded as an arc constituting a part of a circle around an outer perimeter of the inner zone Z1, a central angle θ₂ of each arc is preferably within the range from 6.0 to 10.0°, more preferably from 6.0 to 8.0°. With this setting, if the angle θ₁ of deviation is within the above-described range, it is possible to reliably prevent the circumferential positions of the first junction 24 and the second junction 26 from coinciding with the circumferential position of the boundary region B and more effectively achieve more satisfactory thermal uniformity.

The ceramic plate 12 may further include an RF electrode 30 and/or an ESC electrode. In this case, the RF electrode 30 and/or the ESC electrode is preferably embedded at a depth position, in the ceramic plate 12, closer to the first surface 12a than the inner zone heater circuit 14 and the jumpers 22 are. The RF electrode allows deposition by a plasma CVD process when a high-frequency wave is applied. The ESC electrode is an abbreviation for an electrostatic chuck (ESC) electrode and is also called an electrostatic electrode. The ESC electrode chucks a wafer placed on a surface of the ceramic plate 12 by a Johnsen-Rahbek force when a voltage is applied by the external power source. The ESC electrode is preferably a circular thin-layer electrode slightly smaller in diameter than the ceramic plate 12 and can be, for example, a mesh-like electrode obtained by reticularly weaving thin metal lines into sheet form. The ESC electrode can also be used as a plasma electrode. That is, the ESC electrode can also be used as an RF electrode by applying a high-frequency wave to the ESC electrode and can also perform deposition by the plasma CVD process. An RF terminal 32 for power feeding or an ESC terminal is connected to the RF electrode 30 or the ESC electrode. The RF terminal 32 or the ESC terminal is rod-shaped, and the RF electrode 30 or the ESC electrode is connected to the external power source (not shown) via the rod-shaped RF terminal 32 or the ESC terminal.

Optionally, a ceramic shaft 28 may be concentrically attached to the second surface 12b of the ceramic plate 12. The ceramic shaft 28 is a cylindrical member including an internal space S and can have the same configuration as a ceramic shaft which is adopted by a publicly known ceramic susceptor or ceramic heater. The internal space S is configured such that a terminal rod, such as the first feeding terminal 18, the second feeding terminal 20, or the RF terminal 32, passes therethrough. The ceramic shaft 28 is preferably made of the same ceramic material as the ceramic plate 12. Thus, the ceramic shaft 28 preferably contains aluminum nitride or aluminum oxide, more preferably aluminum nitride. An upper end face of the ceramic shaft 28 is preferably bonded to the second surface 12b of the ceramic plate 12 by solid-phase bonding or diffusion bonding. An outer diameter of the ceramic shaft 28 is not particularly limited and is, for example, about 44 mm. An inner diameter of the ceramic shaft 28 (a diameter of the internal space S) is also not particularly limited and is, for example, about 39 mm.

### EXAMPLES

The present invention will be more specifically described taking the examples below. Note that the present invention is not limited to the examples.

### Example 1

### (1) Fabrication of Multizone Ceramic Heater

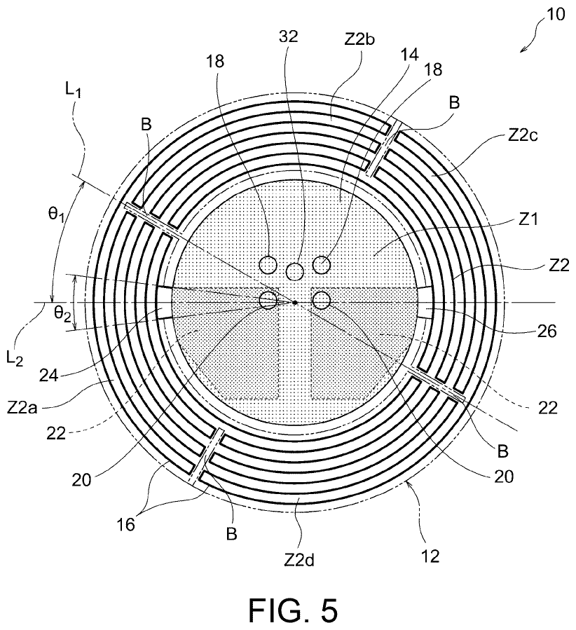

A multizone ceramic heater 10 that had the sectional structure shown in FIG. 2 and a planar arrangement shown in FIG. 5 and met conditions shown in Table 1 was fabricated using the constituent members shown below by a publicly known procedure.

### <Constituent Member and Specification Thereof>

Ceramic plate 12: a disk-shaped aluminum nitride sintered body (having a diameter of 340 mm and a thickness of 18 mm) (one with an inner zone heater circuit 14, an outer zone heater circuit 16, jumpers 22, and an RF electrode 30 embedded therein)
Ceramic shaft 28: a cylindrical aluminum nitride sintered body (having a height of 170 mm, an outer diameter of 45 mm, and an inner diameter of 39 mm).
Inner zone Z1: a circular region having a diameter of 240 mm located at the center of the ceramic plate 12
Outer zone Z2: an annular region outside the inner zone Z1 in the ceramic plate 12 which had four outer subzones Z2a, Z2b, Z2c, and Z2d divided by linear boundary regions B extending in a radial direction.
Inner zone heater circuit 14: a printed pattern as a resistance heating element shown in FIG. 5 which was embedded at a position having a depth of 6 mm from a first surface 12a in the inner zone Z1
Outer zone heater circuit 16: a printed pattern as a parallel circuit composed of a resistance heating element shown in FIG. 5 which was embedded at a position having a depth of 12 mm from the first surface 12a of the outer zone Z2, angles θ₁ of deviation of a first junction 24 and a second junction 26 from the boundary regions B being 20°
Jumpers 22: a bilaterally symmetric printed pattern composed of a resistance heating element shown in FIG. 5 which was embedded at a position having a depth of 12 mm from the first surface 12a in the inner zone Z1 (see Table 1 for a thickness ratio and an area percentage)
Resistance heating element: a tungsten carbide-titanium nitride composite material (common to the inner zone heater circuit 14, the outer zone heater circuit 16, and the jumpers 22)
RF electrode 30: an electrode layer made of molybdenum which was embedded at a position having a depth of 1 mm from the first surface 12a of the ceramic plate 12.
First feeding terminals 18: two terminal rods made of nickel.
Second feeding terminals 20: two terminal rods made of nickel
RF terminal 32: one terminal rod made of nickel.
First junction 24 and second junction 26: arc-shaped portions having central angles θ₂ of 6.0° (end portions of the jumpers 22)

The ceramic plate 12 with the inner zone heater circuit 14, the outer zone heater circuit 16, the jumpers 22, and the RF electrode 30 embedded therein was fabricated by the procedure below. First, two disk-shaped aluminum nitride sintered bodies were provided. The inner zone heater circuit 14 was printed on one aluminum nitride sintered body with a predetermined pattern. The outer zone heater circuit 16 and the jumpers 22 were printed on the other aluminum nitride sintered body with patterns shown in FIG. 5. At that time, thicknesses of the jumpers 22 and the outer zone heater circuit 16 were controlled such that a ratio of the thickness of the jumper 22 to the thickness of the outer zone heater circuit 16 was 1.2 after firing. Aluminum nitride powder and the RF electrode 30 were press-molded to obtain an aluminum nitride green compact with the RF electrode 30 embedded therein. The aluminum nitride green compact and the aluminum nitride sintered bodies with the printed patterns were stacked so as to have a layer structure shown in FIG. 2, and were press-molded. An obtained press-molded body (multilayer body) was fired at from 1750 to 1850° C. for three hours under a nitrogen atmosphere to obtain the ceramic plate 12 with the inner zone heater circuit 14, the outer zone heater circuit 16, the jumpers 22, and the RF electrode 30 embedded therein.

### (2) Assessment

The multizone ceramic heater 10 was installed in a chamber of a deposition apparatus. A vacuum was drawn on the chamber, N₂ gas was introduced into the chamber, and an N₂ gas pressure in the chamber was set to 5 Torr. The multizone ceramic heater 10 was heated to a set temperature of 650° C. by feeding power to the inner zone heater circuit 14 and the outer zone heater circuit 16 via the first feeding terminal 18, the second feeding terminal 20, and the jumpers 22. At the set temperature, a temperature distribution at the first surface 12a of the ceramic plate 12 was measured by an infrared camera. A difference between a maximum temperature and a minimum temperature in a plane (i.e., an in-plane maximum temperature difference) was obtained as an indicator of thermal uniformity on the basis of an obtained temperature distribution map. A result was as shown in Table 1.

### Example 2

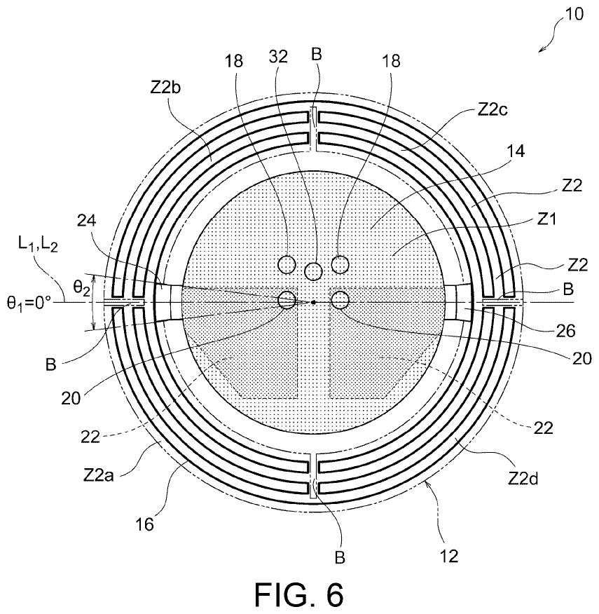

As shown in FIG. 6 and Table 1, fabrication and assessment of a multizone ceramic heater 10 were performed in the same manner as in Example 1, except that angles θ₁ of deviation of centers of a first junction 24 and a second junction 26 from boundary regions B were set to 0°. A result was as shown in Table 1.

### Example 3

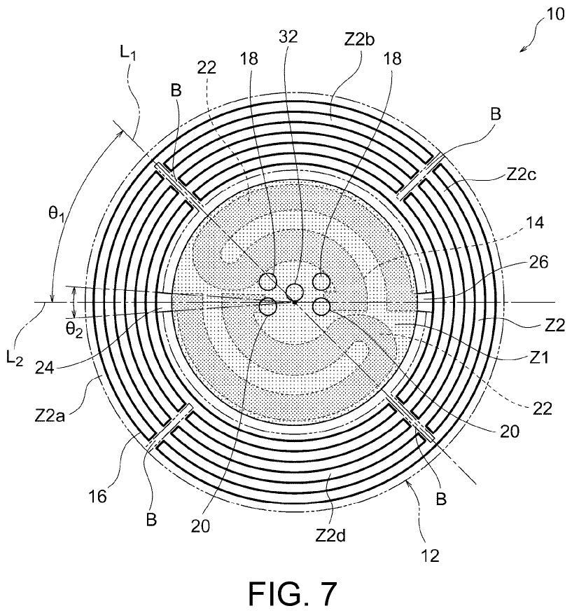

As shown in FIG. 7 and Table 1, fabrication and assessment of a multizone ceramic heater 10 were performed in the same manner as in Example 1, except 1) that angles θ₁ of deviation of a first junction 24 and a second junction 26 from boundary regions B were set to 45° and 2) that a shape of each jumper was set to a spiral shape occupying 76% of an area of an inner zone Z1. A result was as shown in Table 1.

### Example 4

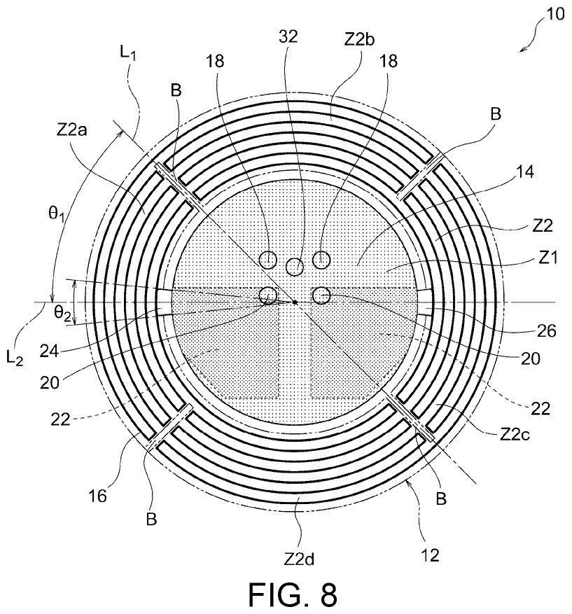

As shown in FIG. 8 and Table 1, fabrication and assessment of a multizone ceramic heater 10 were performed in the same manner as in Example 1, except 1) that angles 01 of deviation of a first junction 24 and a second junction 26 from boundary regions B were set to 45° and 2) that a ratio of a thickness of a jumper 22 to a thickness of an outer zone heater circuit 16 was set to 2.0. A result was as shown in Table 1.

### Example 5

As shown in FIG. 7 and Table 1, fabrication and assessment of a multizone ceramic heater 10 were performed in the same manner as in Example 3, except that a ratio of a thickness of a jumper 22 to a thickness of an outer zone heater circuit 16 was set to 2.0. A result was as shown in Table 1.

### Example 6

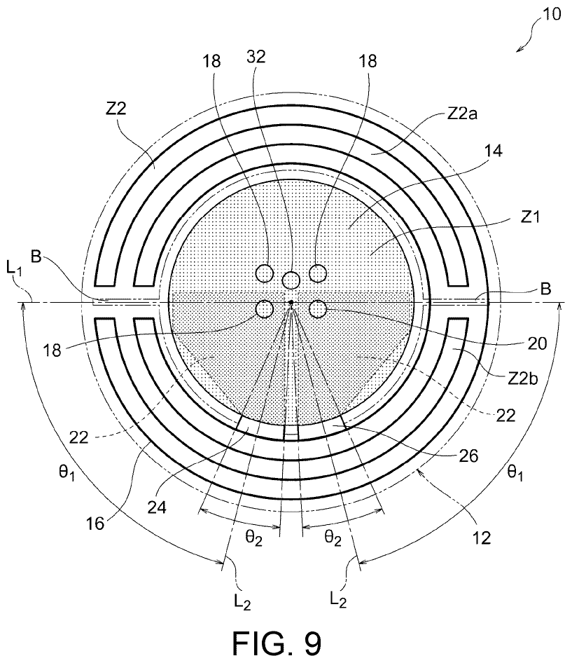

As shown in FIG. 9 and Table 1, fabrication and assessment of a multizone ceramic heater 10 were performed in the same manner as in Example 1, except 1) that an outer zone Z2 was divided into two outer subzones Z2a and Z2b by two boundary regions B extending in a radial direction, 2) that an outer zone heater circuit 16 was constructed as a series circuit, 3) that angles θ₁ of deviation of a first junction 24 and a second junction 26 from boundary regions B were set to 77°, and 4) that a ratio of a thickness of a jumper 22 to a thickness of the outer zone heater circuit 16 was set to 2.0. A result was as shown in Table 1.

### Example 7

As shown in FIG. 8 and Table 1, fabrication and assessment of a multizone ceramic heater 10 were performed in the same manner as in Example 1, except 1) that angles θ₁ of deviation of a first junction 24 and a second junction 26 from boundary regions B were set to 45° and 2) that a ratio of a thickness of a jumper 22 to a thickness of an outer zone heater circuit 16 was set to 3.0. A result was as shown in Table 1.

### Example 8 (Comparison)

As shown in FIG. 8 and Table 1, an attempt to fabricate a multizone ceramic heater 10 was made in the same manner as in Example 1, except 1) that angles θ₁ of deviation of a first junction 24 and a second junction 26 from boundary regions B were set to 45° and 2) that a ratio of a thickness of a jumper 22 to a thickness of an outer zone heater circuit 16 was set to 4.0. However, as shown in Table 1, breakage occurred near a junction (level-difference portion) between the jumper 22 and the outer zone heater circuit 16 during ceramic heater manufacture, and the function of the multizone ceramic heater 10 was impaired. For this reason, thermal uniformity failed to be assessed. The breakage is estimated to be because a stress generated in a ceramic plate formation process was increased in a ceramic plate firing process and concentrated on the level-difference portion.

### Example 9 (Comparison)

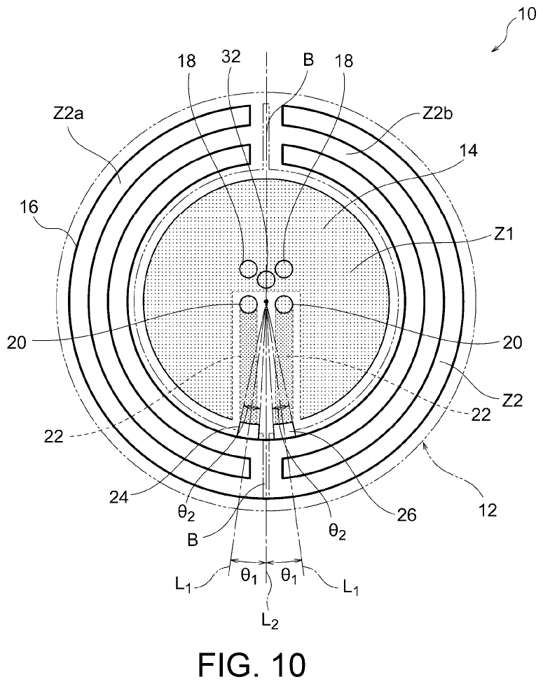

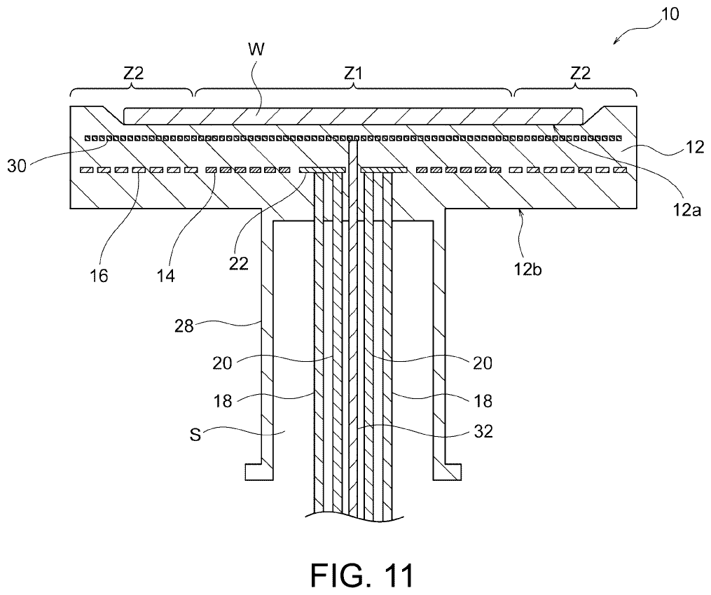

As shown in FIGS. 10 and 11 and Table 1, fabrication and assessment of a multizone ceramic heater 10 were performed in the same manner as in Example 1, except 1) that a one-layer structure with an inner zone heater circuit 14 at the same depth position as an outer zone heater circuit 16 and a jumper 22 was adopted, 2) that an outer zone Z2 was divided into two outer subzones Z2a and Z2b by two boundary regions B extending in a radial direction, 3) that the outer zone heater circuit 16 was constructed as a series circuit, 4) that one pair of jumpers 22 was constructed like two parallel narrow strips, 5) that angles θ₁ of deviation of a first junction 24 and a second junction 26 from boundary regions B were set to 0°, and 6) that a ratio of a thickness of the jumper 22 to a thickness of the outer zone heater circuit 16 was set to 1.0. In the multizone ceramic heater 10 according to the present example, since the inner zone heater circuit 14, the outer zone heater circuit 16, and the jumpers 22 were provided as a one-layer structure with resistance heating elements, as shown in FIGS. 10 and 11, the inner zone heater circuit 14 could not be arranged in a portion with the jumper 22 of the structure. A result was as shown in Table 1.

### Example 10 (Comparison)

As shown in FIG. 6 and Table 1, fabrication and assessment of a multizone ceramic heater 10 were performed in the same manner as in Example 1, except 1) that angles θ₁ of deviation of a first junction 24 and a second junction 26 from boundary regions B were set to 0° and 2) that a ratio of a thickness of a jumper 22 to a thickness of an outer zone heater circuit 16 was set to 1.0. A result was as shown in Table 1.

### Example 11 (Comparison)

As shown in Table 1, fabrication and assessment of a multizone ceramic heater 10 were performed in the same manner as in Example 3, except 1) that angles θ₁ of deviation of a first junction 24 and a second junction 26 from boundary regions B were set to 20° and 2) that a ratio of a thickness of a jumper 22 to a thickness of an outer zone heater circuit 16 was set to 1.0. A result was as shown in Table 1.

TABLE 1

| | | Positional | Ratio of | | | | | | Thermal | |
|---|---|---|---|---|---|---|---|---|---|---|
| | | Relationship | Thickness of | | | | | Central | Uniformity | |
| | | between | Jumper to | Jumper | | | Angle θ₁ of | Angle θ₂ | (In-Plane | |
| | | Inner Zone | Thickness of | | Percentage | | Deviation of | of Arc- | Maximum | |
| | Corre- | Heater and | Outer Zone | | of Area to | | Junction from | Shaped | Temperature | Breakage |
| | sponding | Outer Zone | Heater | | Inner Zone | Circuit | Boundary | Junction | Difference) | during |
| | FIGS. | Heater | Circuit | Shape | [%] | Type | Region [°] | [°] | [° C.] | Manufacture |
| Ex. 1 | FIGS. 2 | two-layer | 1.2 | bilaterally | 38 | parallel | 20 | 6.0 | 1.7 | absent |
| | and 5 | structure | | symmetric | | | | | | |
| Ex. 2 | FIGS. 2 | with different | 1.2 | bilaterally | 38 | parallel | 0 | 9.5 | 3.2 | absent |
| | and 6 | depth | | symmetric | | | | | | |
| Ex. 3 | FIGS. 2 | positions | 1.2 | spiral shape | 76 | parallel | 45 | 7.0 | 1.9 | absent |
| | and 7 | | | | | | | | | |
| Ex. 4 | FIGS. 2 | | 2.0 | bilaterally | 38 | parallel | 45 | 6.0 | 1.2 | absent |
| | and 8 | | | symmetric | | | | | | |
| Ex. 5 | FIGS. 2 | | 2.0 | spiral shape | 76 | parallel | 45 | 6.5 | 1.4 | absent |
| | and 7 | | | | | | | | | |
| Ex. 6 | FIGS. 2 | | 2.0 | bilaterally | 38 | series | 77 | 9.0 | 1.5 | absent |
| | and 9 | | | symmetric | | | | | | |
| Ex. 7 | FIGS. 2 | | 3.0 | bilaterally | 38 | parallel | 45 | 6.0 | 1.1 | absent |
| | and 8 | | | symmetric | | | | | | |
| Ex. 8* | FIGS. 2 | | 4.0 | bilaterally | 38 | parallel | 45 | 6.0 | unmeasurable | present |
| | and 8 | | | symmetric | | | | | due to | |
| | | | | | | | | | breakage | |
| Ex. 9* | FIGS. 10 | one-layer | 1.0 | two strips | 16 | series | 0 | 10.5 | 7.5 | absent |
| | and 11 | structure with | | | | | | | | |
| | | the same depth | | | | | | | | |
| | | position | | | | | | | | |
| Ex. 10* | FIGS. 2 | two-layer | 1.0 | bilaterally | 38 | parallel | 0 | 12.0 | 5.8 | absent |
| | and 6 | structure with | | symmetric | | | | | | |
| | | different depth | | | | | | | | |
| Ex. 11* | FIG. 2 | positions | 1.0 | spiral shape | 76 | parallel | 20 | 11.0 | 4.4 | absent |

*represents a comparative example.

What is claimed is:

1. A multizone ceramic heater comprising:
a disk-shaped ceramic plate having a first surface on which a wafer is to be placed and a second surface opposite to the first surface, the ceramic plate including an inner zone defined as a circular region within a predetermined distance from a center of the ceramic plate and an outer zone defined as an annular region outside the inner zone when the ceramic plate is viewed in plan view;
an inner zone heater circuit embedded parallel to the first surface in the inner zone of the ceramic plate;
an outer zone heater circuit embedded parallel to the first surface at a depth position different from the inner zone heater circuit in the outer zone of the ceramic plate;
one pair of first feeding terminals for feeding power to the inner zone heater circuit which are provided at a central portion of the inner zone of the ceramic plate;
one pair of second feeding terminals for feeding power to the outer zone heater circuit which are provided at the central portion of the inner zone of the ceramic plate; and
one pair of jumpers separated from each other which are embedded parallel to the first surface at a same depth position as the outer zone heater circuit in the inner zone of the ceramic plate, one of the one pair of jumpers electrically connecting one of the second feeding terminals and the outer zone heater circuit by a first junction, the other of the one pair of jumpers electrically connecting the other of the second feeding terminals and the outer zone heater circuit by a second junction at a position different from the first junction,
wherein each of the inner zone heater circuit, the outer zone heater circuit, and the jumpers is a low-profile element composed of a resistance heating element selected from the group consisting of a printed pattern, foil, perforated metal, and a mesh, and
wherein thicknesses of the jumpers are from 1.2 to 3.0 times a thickness of the outer zone heater circuit.

2. The multizone ceramic heater according to claim 1, wherein the outer zone is composed of a plurality of outer subzones demarcated by dividing the outer zone into arc shapes, and linear boundary regions which are not crossed by the outer zone heater circuit are present in a radial direction of the ceramic plate between the outer subzones adjacent in a circumferential direction so as not to completely split the outer zone, and
wherein the outer zone heater circuit is provided to start from the first junction in one direction or two directions, and meander, for each of the start directions, through a single continuous course while alternating travel in the circumferential direction and turnback in front of the boundary region so as to pass through a generally entire region of each of the plurality of outer subzones, and arrive at the second junction.

3. The multizone ceramic heater according to claim 2, wherein when the ceramic plate is viewed in plan view, the boundary region and each of the first junction and the second junction are arranged to be spaced such that an angle which a straight line through a center in the circumferential direction of the boundary region closest to the junction and a center of the ceramic plate forms with a straight line through the center in the circumferential direction of the junction and the center of the ceramic plate is equal to or more than 20°.

4. The multizone ceramic heater according to claim 2, wherein when each of the first junction and the second junction is regarded as an arc constituting a part of a circle around an outer perimeter of the inner zone, a central angle of each of the arcs is within the range from 6.0 to 10.0°.

5. The multizone ceramic heater according to claim 2, wherein the outer zone heater circuit is provided to start from the first junction in one direction and arrive at the second junction through a single continuous course so as to form a series circuit.

6. The multizone ceramic heater according to claim 2, wherein the outer zone heater circuit is provided to start from the first junction in two directions and arrive, for each of the start directions, at the second junction through a single continuous course so as to form a parallel circuit.

7. The multizone ceramic heater according to claim 1, wherein when the ceramic plate is viewed in plan view, each of the one pair of jumpers and the one pair of second feeding terminals is arranged symmetric with respect to a perpendicular bisector of a line segment connecting the one pair of second feeding terminals.

8. The multizone ceramic heater according to claim 1, wherein each of the inner zone heater circuit, the outer zone heater circuit, and the jumpers has the form of a printed pattern.

9. The multizone ceramic heater according to claim 1, wherein the thickness of the outer zone heater circuit is uniform in an in-plane direction, and the thicknesses of the jumpers are uniform in the in-plane direction.

10. The multizone ceramic heater according to claim 1, further comprising an RF electrode and/or an ESC electrode embedded at a depth position, closer to the first surface than the inner zone heater circuit and the jumpers are, in the ceramic plate.

11. The multizone ceramic heater according to claim 1, wherein the ceramic plate contains aluminum nitride or aluminum oxide.

12. The multizone ceramic heater according to claim 1, further comprising a cylindrical ceramic shaft which is concentrically attached to the second surface of the ceramic plate and includes an internal space.

13. The multizone ceramic heater according to claim 1, wherein the resistance heating element contains at least one selected from the group consisting of tungsten, molybdenum, a tungsten-molybdenum alloy, tungsten carbide, a tungsten carbide-titanium nitride composite material, and a tungsten carbide-aluminum oxide composite material.

14. The multizone ceramic heater according to claim 1, wherein the thicknesses of the jumpers are from 1.8 to 3.0 times the thickness of the outer zone heater circuit.
